(19) United States
(12) Patent Application Publication
(10) Pub. No.: US 2011/0119285 A1
(43) Pub. Date: May 19, 2011

(54) Semantic computing system

(76) Inventor: Chen-Yu Sheu, Irvine, CA (US)

(21) Appl. No.: 12/590,827

(22) Filed: Nov. 16, 2009

(51) Int. Cl. G06F 17/30

(52) U.S. Cl. 707/760; 707/E17.073

(57) ABSTRACT

This invention is related to providing a semantic computing system (SCS) that allows user(s) of a computing system (a desktop computer, a cell phone, a server or a network of computers) to create, search, use and manipulate its resources (including personal and shared data resources such as files and database records, and personal and shared tool resources such as programs and devices) based on commands and annotations expressed in natural language.

### BACKGROUND OF THE INVENTION

1. Field of the Invention

This invention is related to providing a semantic computing system (SCS) that allows user(s) of a computing system (a desktop computer, a cell phone, a server or a network of computers) to create, search, use and manipulate its resources (including personal and shared data resources such as files and database records, and personal and shared tool resources such as programs and devices) based on commands and annotations expressed in natural language.

2. Description of the Related Art

Most modern computing systems (e.g., Windows) are icon and menu driven. Such systems are restricted because:
1. It is difficult to locate a data resource as it may be buried somewhere in a hierarchical folder system or on the Internet.
2. It is difficult to locate a tool resource from a menu when there are too many tools available locally or when it is only available on the Internet.
3. It is sometimes difficult to use a tool due to the rich set of functions available and due to the complex workflow involved.
4. Users cannot access objects stored in a database directly as they access files.

An alternative way to access data and tool resources is to use a command language. Unix, for example, has a set of commands available to the user. However the existing command languages are very restricted. For example, in Unix a command is a verb followed by a set of nouns, where the verb is basically the name of a program and no condition clauses is allowed. In addition, the arguments (i.e., the nouns) of a command are usually restricted to file names; they cannot be logical objects or descriptions of logical objects.

It is therefore desired that a user can interact with the resources in a computing system via a command language that is based on natural language, where a resource may be an internal resource on a computer such as a file, a program or any logical object, or it may be an Internet resource such as a service or a web document, where the resources needed can be derived and applied from a command sentence.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

This invention provides a semantic computing system for a computing system (a desktop computer, a cell phone, a server or a network of computers) that allows its user(s) to search, use, create and/or manipulate the resources in natural language. This is different from traditional computing systems that are driven by menus, icons or simple commands with command-line arguments.

### DETAILED DESCRIPTION OF THE PREFERRED EMBODIMENT

The following subsections describe a semantic computing system that embodies various inventive features. The various inventive features can be implemented differently than described herein. Thus, the following description is intended only to illustrate, and not limit, the scope of the present invention.

### Architecture of SCS

A Semantic Computing System (SCS) runs on top of an existing computing system to provide the user with a natural language interface to search, use, create and/or manipulate resources in the system, where
(A) A computer system may be a desktop computer, a server that is shared by multiple users, a cell phone that is capable of performing computational tasks, or a set of computers connected by a network including the Internet.
(B) A resource may be personal resource on a computer such as a file, a program or any logical object, or it may be an Internet resource such as a service or a web document. Another classification of resources is that programs and services are tool resources, and files, data objects and web documents are data resources.

The architecture of an SCS is shown in FIG. 1:
1. Command Sentence User Interface 110, an interface through which a user can compose an imperative sentence as a command.
2. Annotation User Interface 120, an interface through which a user can compose an annotation for a resource in natural language. In the case that the computing system is shared by multiple users, each user can have a personal annotation for a resource.
3. Annotation database 130 that sores all annotations of resources.
4. Command Processor 140 that parses a command and executes the command.

In the case the computing system is shared by multiple users, the SCS also creates a mailbox for each resource, each command sentence that has been posted, each user, and any group of the above that can be defined by the administrator. The SCS has a Communication Processor that allows users to communicate by sending/receiving messages to/from a mailbox. In this case, a message, a user or a mailbox is also considered a data resource.

Following are some example command sentences.

Example 1: Given a dataset of images, classify blobs of images in a dataset.

Classify blobs of image from image “skd-1”

Example 2: Open a file that describes how to make cookies.

Open file that describes how to make cookies

Example 3: Open a file with the name “semantic”.

Open file whose name is “semantic”

Example 4: Look up dictionary.

Look up dictionary

Example 5: Look up dictionary and find definition for the word “semantic”.

Look up dictionary for definition of the word “semantic”

Example 6: Change the wall paper (of the monitor) to winter with snow flakes.

Change wall paper to Winter with snow flakes

A data resource in an SCS is annotated by a noun phrase.

Example 7: A file with the name “semantic”.

a file whose name is “semantic”

A tool resource in an SCS is annotated using an imperative sentence.

Example 8: Given a dataset, find distribution of some variables over others.

Find distribution of a variable over a list of variables in a dataset

Example 9: Given a set of video clips, find those containing a scene similar to a given scene.

Find clips of a dataset of video clips that are similar to a video clip

A data resource in an SCS may be annotated at the time it is created. For example, in Example 2 and Example 3 if the target file resource does not exist, the noun phrase becomes the annotation of the file data resource. A resource may also be annotated after it is created.

FIG. 2 shows one embodiment of a computer-implemented process of an SCS. At a block 210, a user composes a command sentence. The command sentence is matched against the annotations of the tool resources in a block 220. The noun phrases of the command sentence are identified and matched against the annotations of the data resources in a block 230 to identify one or more data resources that may serve as an argument for a tool resource. If the command sentence is determined to be sufficient and appropriate to be mapped to a tool resource and its arguments, the data resources are passed to the tool resource for execution in a block 240.

### BRIEF DESCRIPTION OF THE DRAWINGS

FIG. 1 illustrates one embodiment of a semantic computing system

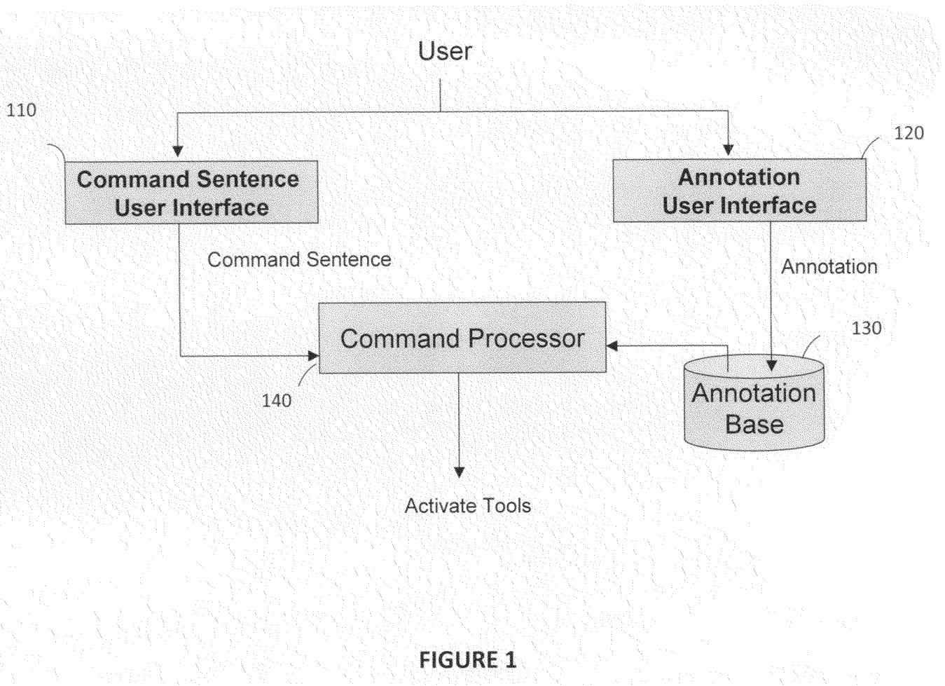

FIG. 2 illustrates one embodiment of the control flow of a semantic computing system

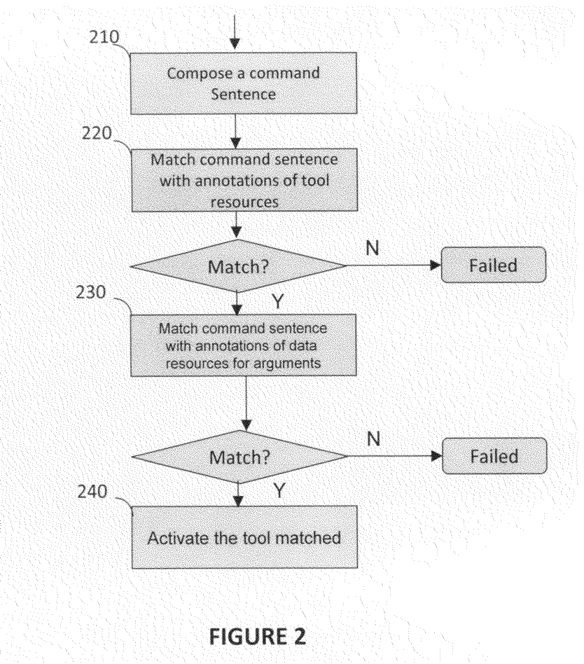

What is claimed is:

1. A semantic computing system for a computing system, the semantic computing system comprising
a computer interface that can be connected to a user that allows the user to compose a command sentence in natural language;
a computer interface that can be connected to a user that allows the user to compose an annotation for a resource in natural language;
an annotation database that stores the annotations created;
a command processor that parses a command sentence, searches for the resources needed to execute the command, and activates one or more tools with the necessary arguments to execute the command.

2. The system of claim 1, further comprising a computer can be a personal desktop computer, a cell phone capable of performing computational tasks, a server shared by multiple users, or a set of computers connected by a network.

3. The system of claim 1, further comprising a module that requests the user to choose a resource if multiple resources are identified as candidates for the same role (data or tool) in a command.

4. The system of claim 1, further comprising that multiple annotations may be defined for a resource.

5. The system of claim 1, further comprising that a URL may be considered as a tool and/or data resource.

6. The system of claim 1, further comprising that each annotation for a data resource is expressed in the form of a noun phrase.

7. The system of claim 1, further comprising that each annotation for a tool resource is expressed in the form of an imperative sentence.

8. The system of claim 1, further comprising that a command is expressed in the form of an imperative sentence.

9. The system of claim 1, further comprising that a program is a tool resource.

10. The system of claim 1, further comprising that a data or document file is a data resource.

11. The system of claim 1, further comprising that a device that can be accessed by the computer system is a tool and/or data resource.

12. The system of claim 1, further comprising that any record or set of records of a database is a data resource.

13. The system of claim 1, further comprising a communication processor if the computing system is shared by multiple users and it allows users to communicate by sending/receiving messages to/from a mailbox that is created for each resource, each command sentence that has been posted, each user, and any group of the above that can be defined by the administrator; in this case, a message, a user or a mailbox is also a data resource.

14. A computer-implemented method of problem solving in a semantic computing system, the method comprising:
prompting a user to compose an imperative command sentence;
matching the noun phrases in the command sentence with the annotations of the data resources available in the system to identify those data resources that may serve as an argument to a tool resource;
matching the command sentence with the annotation sentence(s) of the tool resources available in the system to identify tool resources whose annotation may match a part of or the entire command sentence;
determining a tool resource and one or more data resources whose annotations combined can match a noun phrase in the command sentence;
passing the identified one or more data resources as arguments to the identified tool resource for execution.

15. The method of claim 14, further comprising that a command sentence may be matched by combining more than one tool resources.

16. The method of claim 14, further comprising that a tool resource whose annotation that partially matches the command sentence is returned as a candidate.

17. The method of claim 14, further comprising that the user is prompted to choose a tool resource when multiple tool resources are identified as candidates.

18. The method of claim 14, further comprising that the user is prompted to choose a data resource when multiple data resources are identified as candidates as a parameter of a tool resource.

19. The method of claim 14, further comprising that if a data resource cannot be found to match a noun phrase of the command sentence, a new data resource is created with the noun phrase as its annotation and the data resource is used as an argument for the tool identified.

20. The method of claim 14, further comprising that if a login name and a password are required by the tool resource, the login name and password can be pre-stored in a database by the user so that they can be retrieved and passed to the tool resource automatically when the tool resource is activated by the command processor.

21. The method of claim 14, further comprising that if multiple tool resources whose annotations can match the command sentence, one may be pre-assigned to be the default tool resource to execute for the command sentence; the assignment together with the command sentence are stored in a database so that next time when the same command sentence is posted the default tool resource can be automatically selected for activation.

22. The method of claim 14, further comprising that each annotation for a data resource is expressed in the form of a noun phrase.

23. The method of claim 14, further comprising that each annotation for a tool resource is expressed in the form of an imperative sentence.

24. The method of claim 14, further comprising that a command is expressed in the form of an imperative sentence.
